(19) United States
(12) Patent Application Publication
(10) Pub. No.: US 2024/0267862 A1
(43) Pub. Date: Aug. 8, 2024

(54) TA UPDATE DURING UPLINK TRANSMISSION

(71) Applicant: LENOVO (BEIJING) LIMITED, Beijing (CN)

(72) Inventors: Zhi YAN, Beijing (CN); Hongmei LIU, Beijing (CN); Yuantao ZHANG, Beijing (CN); Haiming WANG, Beijing (CN)

(21) Appl. No.: 18/249,124

(22) PCT Filed: Oct. 14, 2020
(86) PCT No.: PCT/CN2020/120780

§ 371 Date: Apr. 14, 2023

(51) Int. Cl. H04W 56/00

(52) U.S. Cl. CPC H04W 56/0045

(57) ABSTRACT

Methods and apparatuses for updating TA during uplink transmission are disclosed. A method comprises transmitting uplink data on a physical resource, wherein, the uplink data is dropped in a first time duration (Y) every a time period (X), the first time duration (Y) is in a first part and/or an end part of the time period (X).

### FIELD

The subject matter disclosed herein generally relates to wireless communications, and more particularly relates to methods and apparatuses for updating TA during uplink transmission.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal) (UE), non-terrestrial networks (NTN), terrestrial network (TN), timing advance (TA), Machine-Type Communication (MTC), enhanced MTC (eMTC), Internet-of-Things (IoT), Narrowband Internet-of-Things (NB-IoT or NBIOT), Physical Uplink Shared Channel (PUSCH), NB-IoT PUSCH (NB-PUSCH, NPUSCH), Downlink control information (DCI), Low Earth Orbit (LEO), Cyclic Prefix (CP), Half Duplex Frequency Division Duplex (HD-FDD), Random Access Channel (RACH), Physical Random Access Channel (PRACH), NB-IoT PRACH (NB-PRACH, NPRACH).

Random access procedure in NTN includes 4 steps as illustrated in FIG. 1. In step 1, when UE has location information and satellite (eNB or gNB) moving information, the UE can estimate distance of UE and eNB or gNB or timing advance (TA) (which is used to adjust the uplink frame timing relative to the downlink frame timing). Then, the UE transmits Msg1 (i.e. random access preamble) to gNB by applying the estimated TA. In step 2, the UE monitors Msg2 (i.e. random access response, which is the response to Msg1) transmitted from the gNB. Msg2 is also used to schedule Msg3 transmitted by the UE. According to the receiving of Msg2, the UE can make correction of TA (e.g. correction of the estimated TA). In step 3, the UE transmits Msg3 by applying the corrected TA. In step 4, the gNB receives Msg3 and derives UE-specific TA information, and then transmits Msg4 (response to Msg3) to the UE.

According to the random access procedure in NTN, even the UE with location information can estimate TA before transmitting Msg1, the estimated TA is not carried in Msg1. Therefore, the gNB has no knowledge of the TA when transmitting Msg2 (i.e. when scheduling Msg3). The TA information is carried only in Msg3. That is, the gNB gets to know the TA information when receiving Msg3.

In the scenario of NTN, the TA can be very large due to long round-trip delay and can be wide range due to large cell range of NTN cell (footprint). The TA can be divided into common TA and UE-specific TA, where the whole TA is equal to the sum of the common TA and the UE-specific TA.

FIG. 2 illustrates the concept of the common TA and the UE-specific TA in NTN for two cases (for regenerative payload and for bent-pipe payload). The common TA is calculated with reference to a reference point, which can be determined as a terrestrial point right below the satellite. The value of common TA is determined by d0 for regenerative payload (i.e. the base station (eNB that is used in scenario of eMTC or NBIOT or gNB that is used in scenario of NR) is located on the satellite) and by d0+d0_F for bent-pipe payload (i.e. the base station (eNB or gNB) is located in a terrestrial place), in which d0 is a distance between the satellite and the reference point in the terrestrial and d0_F is a distance between the satellite and the terrestrial place where the base station is located. The value of UE-specific TA is determined by d1−d0, in which d1 is a distance between the satellite and the UE. As shown in FIG. 2, the UE-specific TA is 2*(d1−d0)/c, in which c is the speed of light; while the common TA (or common reference TA) is 2*d0/c for regenerative payload and is 2*(d0+d0_F)/c for bent-pipe payload.

As can be seen from the above, (d1−d0)/c, d0/c and (d0+d0_F)/c is a propagation delay. The timing advance is twice the value of the propagation delay. The whole TA for regenerative payload is 2*d0/c+2*(d1−d0)/c=2*d1/c; and the whole TA for bent-pipe payload is 2*(d0+d0_F)/c+2*(d1−d0)/c=2*(d1+d0_F)/c.

In NB-IoT Release 16, for NPUSCH, when a coded data is transmitted from the remote unit (e.g. UE) to the base unit (e.g. gNB), it is mapped to one or more resource units (N_{RU}), each of which is transmitted by a number of times (i.e. repetitions) (N_{Rep}).

Table 1 indicates the number of resource units (N_{RU}) being determined by the resource assignment (I_{RU}) for NPUSCH. The resource assignment (I_{RU}) is indicated with 3 bits by the corresponding control signal (e.g., DCI format NO). The resource unit for NPUSCH is determined by the subcarrier spacing of the NPUSCH data.

TABLE 1

| I_{RU} | N_{RU} |
|---|---|
| 0 | 1 |
| 1 | 2 |
| 2 | 3 |
| 3 | 4 |
| 4 | 5 |
| 5 | 6 |
| 6 | 8 |
| 7 | 10 |

Table 2 indicates the repetition number (N_{Rep}) being determined by repetition number index (I_{Rep}) for NPUSCH. The repetition number index (I_{Rep}) for NPUSCH is indicated with 3 bits by the corresponding control signal (e.g., DCI format NO).

TABLE 2

| I_{Rep} | N_{Rep} |
|---|---|
| 0 | 1 |
| 1 | 2 |
| 2 | 4 |
| 3 | 8 |
| 4 | 16 |
| 5 | 32 |
| 6 | 64 |
| 7 | 128 |

The subcarriers to be used for NPUSCH data transmission are different for different subcarrier spacings. For subcarrier spacing of 3.75 KHz, only single-tone (N_{sc}^{RU}=1) is supported. For subcarrier spacing of 15 KHz, both single-tone and multiple-tone are supported. One or three or six or twelve of twelve subcarriers (N_{sc}^{RU}=1 or 3 or 6 or 12) is used within one NBIOT carrier.

In scenario of converge enhancement for NB-IoT, a total duration of a PUSCH transmission may span tens of seconds. Table 3 indicates the maximum total durations of PUSCH transmissions. It can be seen that a PUSCH transmission can span up to 40 s.

TABLE 3

| NPUSCH | | | | Total Duration |
|---|---|---|---|---|
| format | Δf | N_{sc}^{RU} | Nₛₗₒₜₛ^{UL} | N_{Rep=128}, N_{RU=10(format1)} |
| 1 | 3.75 kHz | 1 | 16 | 2*16*10*128 = 40960 ms |
| | 15 kHz | 1 | 16 | 0.5*16*10*128 = 10240 ms |
| | | 3 | 8 | 0.5*8*10*128 = 5120 ms |
| | | 6 | 4 | 0.5*4*10*128 = 2560 ms |
| | | 12 | 2 | 0.5*2*10*128 = 1280 ms |
| 2 | 3.75 kHz | 1 | 4 | 2*4*128 = 1024 ms |
| | 15 kHz | 1 | 4 | 0.5*4*128 = 256 ms |

For NTN network, the satellite (e.g., LEO) is moving with high speed, the propagation delay and frequency between the satellite and UE are always changing.

Suppose that the satellite orbital speed is 7.5 km/s at 600 km altitude and that a minimum elevation angle on earth is approximately 10 degrees, the maximum delay drift between the satellite and UE will be on the order of ±20 μs/s.

For one PUSCH transmission spanning up to 40 s, the delta propagation delay is changed up to 0.8 ms (based on a delay drift of ±20 μs/s) from the beginning to the end of PUSCH transmission. If TA is not updated in a PUSCH transmission (for example, spanning up to 40 s), the TA adopted in the beginning is not suitable in the middle (and at the end) of the PUSCH transmission, because if the delta TA exceeds±T₀ (e.g., CP/2) will destroy OFDM orthogonality.

FIG. 3 illustrates the delta TA in the last symbol for one PUSCH transmission for different NPUSCH formats (NPUSCH formats 1 and 2) and different subcarrier spacings (3.75 kHz or 15 kHz of Δf).

It can be seen that, for NPUSCH format 1, for subcarrier spacing (Δf) of 3.75 kHz and for subcarrier spacing (Δf) of 15 kHz in single tone (N_{sc}^{RU}=1), the delta TA is as much as 5.7 symbols duration.

FIG. 4 illustrates the accumulation of delta TA (i.e. ΔTA). As shown in FIG. 4, delta TA is accumulated with a rate of 1 symbol (T₀) per TA (which is equal to X ms). In this condition, in order to ensure that the TA error does not exceed T₀ (e.g., CP/2), TA should be updated at least every X ms or several repetitions of data transmission during the NPUSCH transmission.

This invention proposes different solutions for updating TA during the NPUSCH transmission.

### BRIEF SUMMARY

Methods and apparatuses for updating TA during uplink transmission are disclosed.

In one embodiment, a method comprises transmitting uplink data on a physical resource; and dropping the uplink data in a first time duration (Y) every a time period (X), wherein the first time duration (Y) is in a first part and/or an end part of the time period (X).

In one embodiment, a gap period of a second time duration (Y0), during which the uplink data is not transmitted, can be inserted after or within a data transmission period (X0), wherein the data transmission period (X0) is configured by higher layer. The data transmission period (X0) may be configured as a multiple of the time period (X).

In another embodiment, the uplink data is dropped every the time period (X) from a first time reference to a second time reference. The first time reference may be at least one of a start of uplink data transmission, a restart of uplink data transmission after the gap period, a restart of uplink data transmission after an invalid time slot, the time period (X) after the start of uplink data transmission, the time period (X) after the gap period, and the time period (X) after the invalid time slot. The second time reference is at least one of a second period (Z) before the gap period, a second period (Z) before the completion of uplink data transmission, and a second period before an invalid time slot. The second period can be one slot duration or 0.

In some embodiment, the uplink data is transmitted in a continuous time duration. The continuous time duration can be divided into a plurality of time periods, in which all of time periods except for the last time period have a time length X, and the last time period has a time length equal or smaller than X. In this condition, the time periods, the end part and/or the first part of each of which are dropped, can be alternatively indicated by the sequence of the time periods. For example, when the first time duration (Y) is in the end part of the time period, the time periods, the end part of each of which is dropped, start from a first time period from a start of the uplink data transmission and end at the second latest time period before the completion of uplink data transmission. When the first time duration (Y) is in the first part of the time period, the time periods, the first part of each of which is dropped, start from a second time period from a start of the uplink data transmission and end at the latest time period before the completion of uplink data transmission. When the first time duration (Y) is in the end part and the start part of the time period, the time periods, the end part of each of which is dropped, start from a first time period from a start of the uplink data transmission and end at the second latest time period before the completion of uplink data transmission, and the time periods, the first part of each of which is dropped, start from a second time period from a start of the uplink data transmission and end at the latest time period before the completion of uplink data transmission.

In some embodiment, the first time duration (Y) can be configured by higher layer or fixed as 1 symbol. The time period (X) can be configured by higher layer or configured as multiple of a preamble duration or configured as multiple repetitions of the uplink data transmission.

In another embodiment, a remote unit comprises a transmitter that transmits uplink data on a physical resource; and a processor that drops the uplink data in a first time duration (Y) every time period (X), wherein the first time duration (Y) is in a first part and/or an end part of the time period (X).

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates a legacy random access procedure;

FIG. 2 illustrates the concept of the common TA and the UE-specific TA in NTN for two cases;

FIG. 3 illustrates the delta TA in the last symbol for one PUSCH transmission for different NPUSCH formats and different subcarrier spacings;

FIG. 4 illustrates the accumulation of delta TA;

FIG. 5 illustrates an example of uplink transmission gap;

FIG. 6 illustrates an example of the first embodiment;

FIGS. 7(a) to 7(c) illustrate examples of the second embodiment;

FIG. 8 illustrates an example of the third embodiment;

FIG. 9 is a schematic flow chart diagram illustrating an embodiment of a method; and

FIG. 10 is a schematic block diagram illustrating apparatuses according to one embodiment.

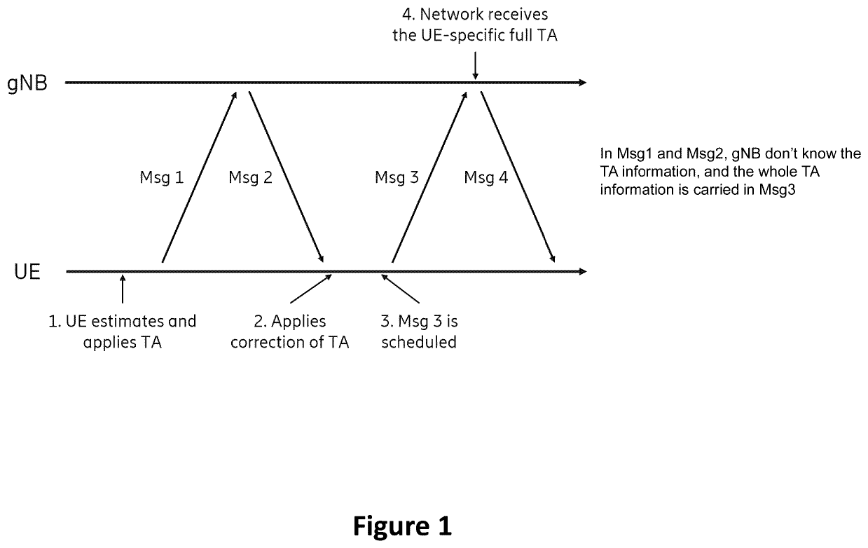

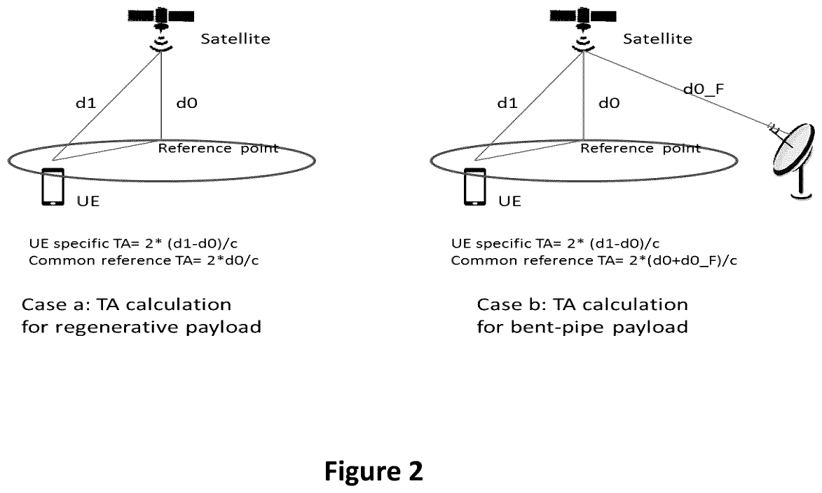

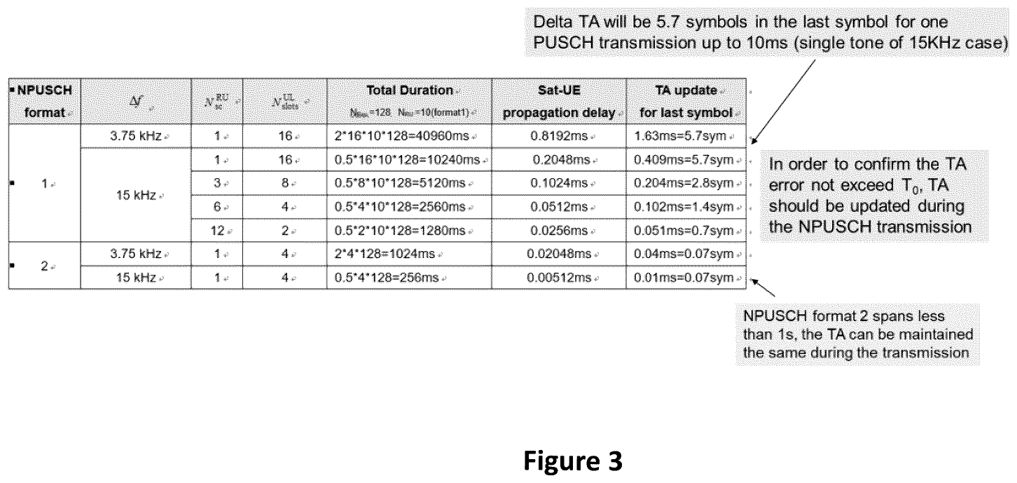

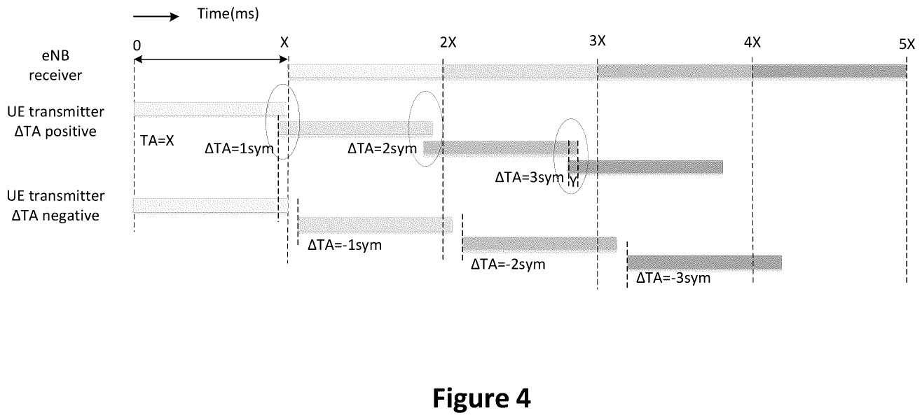

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but d0 not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

According to a first embodiment, the TA update during a NPUSCH transmission can be done in uplink transmission gaps.

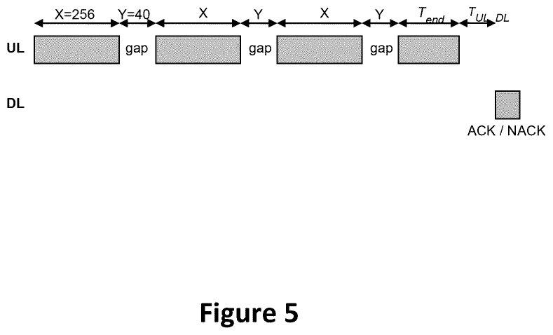

In HD-FDD NB-IoT, it is hard to maintain 0.1 ppm of frequency synchronization accuracy during long uplink transmission with large number of repetitions. In NR Release 13 NB-IoT, uplink transmission gaps are introduced for long uplink (i.e. NB-PUSCH or NB-PRACH) transmissions for DL synchronization. During uplink transmission gaps, the UE may switch to the DL and performs time and frequency synchronization. Uplink transmission gap is defined by a period X and a gap length Y. All uplink transmissions of duration greater than or equal to X ms applies transmission gap with gap length Y and periodicity X until the uplink transmission completes. For NPUSCH as shown in FIG. 5, X=256 ms, and Y=40 ms. For NPRACH, X=64*(preamble duration), Y=40 ms.

The uplink transmission gap design can be used for updating TA in PUSCH transmission. In particular, a transmission gap with length of Y is inserted after or within every X duration from the beginning of the uplink transmission.

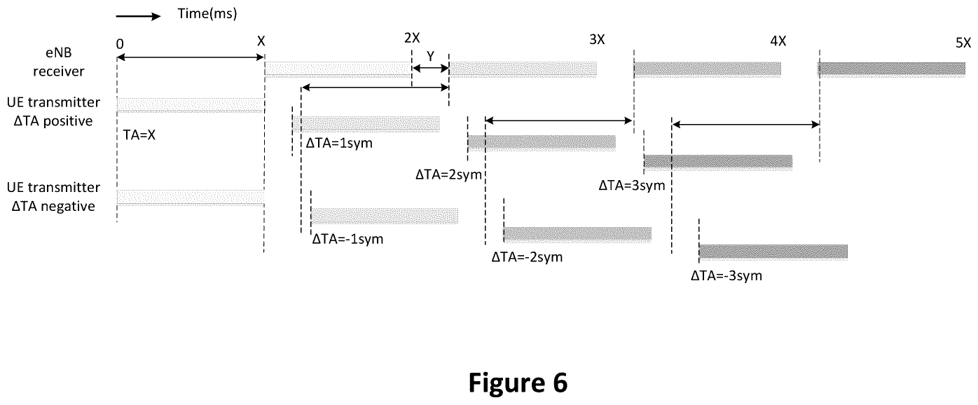

FIG. 6 illustrates an example of the first embodiment, in which a transmission gap with length of Y is inserted after every X duration from the beginning of the uplink transmission.

TA update can be done in each of the transmission gaps. The length Y of the TA gap is configured based on the delta TA. If CP is 5 μs (±2.5 μs) (i.e. To is 2.5 μs), TA should be updated less than every 250 ms (±125 ms) in view of the delay drift of ±20 μs/s. In order to ensure initial TA error margin, X should be smaller than 125 ms. For example, X may be configured as 100 ms, 64 ms or 32 ms, while Y is configured as 1 ms.

Incidentally, for one PUSCH transmission spanning up to 40 s, the Doppler shift is changed up to 10-20 KHz from the beginning to the end of PUSCH transmission, the frequency locked in the beginning of PUSCH transmission is not suitable in the middle (and at the end) of the PUSCH transmission. So, Doppler shift compensation is necessary to be implemented at UE side or gNB side. According to the first embodiment, Doppler shift is compensated in the transmission gap by UE.

For the preamble transmission, X should be a multiple of preamble transmission duration (5.6 ms or 6.4 ms). For example, TA can be updated every X=16*(preamble transmission duration), that is, if preamble transmission duration is 6.4 ms, X is 102.4 ms. Y is configured as 1 ms.

The first embodiment only applies to the situation that the Doppler shift is compensated by UE. According to the first embodiment, both TA and frequency are updated in the periodic transmission gaps during the PUSCH transmission.

In the above description of the first embodiment, the transmission gap (with a length of Y) is inserted after each X duration. According to a variety of the first embodiment, the transmission gap (with a length of Y) can be inserted within each X duration, which is equivalent to inserting a transmission gap (with a length of Y) after each X-Y duration.

According to the first embodiment, a lot of gaps are inserted during the uplink transmission, which leads to transmission delay, resource waste, symbol-level combining invalid, cross channel-estimation interrupt, etc.

Considering that the delta TA (about 1 symbol) is not very large, some symbols are dropped (punctured) for updating TA according to a second embodiment.

According to the second embodiment, UE will drop Y time duration NPUSCH transmission every X ms time interval or every X repetitions of NPUSCH codeword transmission from the initial NPUSCH transmission. The Y time duration is last Y time duration in every X ms or every X repetitions of a NPUSCH codeword transmission, or first Y time duration in every X ms or every X repetitions of a NPUSCH codeword transmission.

Similar to the first embodiment, when the delay drift is ±20 μs/s, X can be configured as 100 ms, 64 ms or 32 ms, while Y is configured as 1 symbol (i.e. 66.7 μs) or half symbol (i.e. 33.3 μs). Alternatively, when X is counted as a multiple of NPUSCH repetitions, X can be configured as 8 repetitions when the delay drift is ±20 μs/s.

For the preamble transmission, X can be configured as a multiple of preamble transmission duration (5.6 ms or 6.4 ms) for the following reason.

NBIOT RACH supports 2 formats. One preamble is comprised of 4 symbol groups with multiple transmission repetitions. One symbol group is 5.6 or 6.4 ms for each format, repetition number can be configured up to 128.

In NR Release 13, NBIOT RACH adopts 2-steps frequency hopping within one carrier. First level single-subcarrier hopping is used between the first and the second symbol groups and between the third and the fourth symbol groups. Second level 6-subcarrier hopping is used between the second and the third symbol groups. Pseudo-random hopping is used between repetitions (each repetition is comprised of 4 symbol groups). Because TA should be maintained the same during one repetition due to the frequency error estimation, the update of TA should not be made within each repetition.

Therefore, the puncture should be made at the end (and/or at the first) of a repetition. That is, X should be configured as a multiple of a repetition (i.e. preamble transmission duration, that is 5.6 ms or 6.4 ms). For example, TA can be updated every X=16*(preamble transmission duration). If preamble transmission duration is 6.4 ms, X is 16*6.4 ms=102.4 ms. Y is configured as 1 symbol.

According to the second embodiment, Doppler shift is post-compensated in the eNB side.

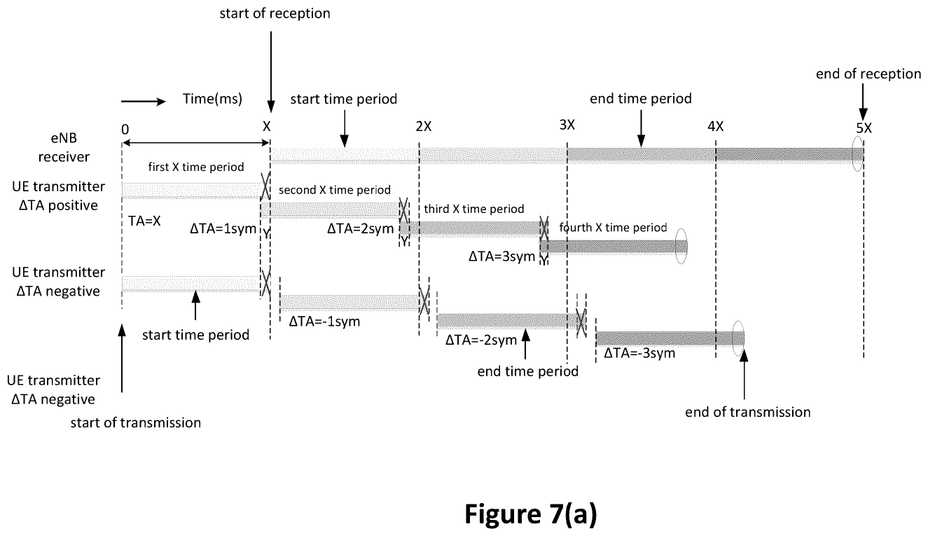

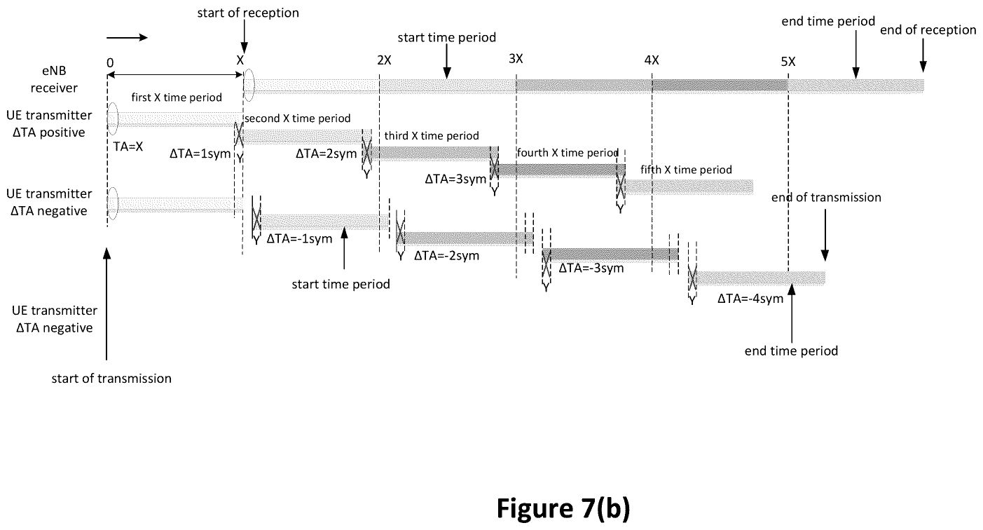

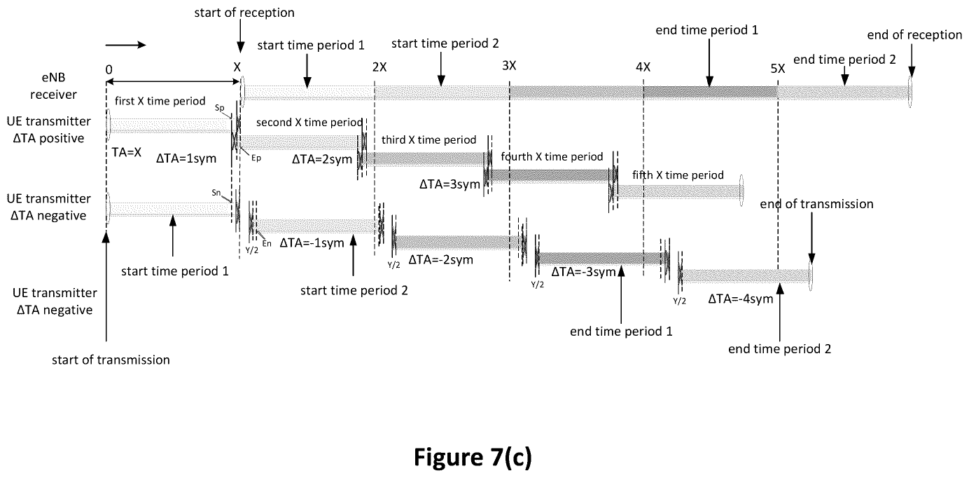

For example, as shown in FIG. 7(a), the last symbol is dropped (i.e. punctured) every X ms uplink transmission or every X repetitions of NPUSCH codeword transmission (each is abbreviated as X time period in FIG. 7(a)), and TA is updated in these punctured durations. It can be seen from FIG. 7(a) that the uplink data transmission spans 4X time duration, and the last symbol is dropped (punctured) from the first X time period (start time period) to the second latest X time period (i.e. the third X time period in FIG. 7(a)) (end time period) of the uplink NPUSCH transmission. Since there is no uplink transmission after the last X time period (the fourth X time period in FIG. 7(a)), it is unnecessary to update TA at the end of the last X time period. Therefore, the last symbol of the last X time period is not dropped. Note that the end of transmission may not be the end of an X time period (e.g. the fourth X time period in FIG. 7(a)), which means that the last X time period may occupy less than X ms or less than X repetitions.

As mentioned earlier, instead of the last symbol, the first symbol can be dropped every X ms uplink transmission or every X repetitions of NPUSCH codeword transmission (each is abbreviated as X time period in FIG. 7(b)), and TA is updated in these punctured durations. It can be seen from FIG. 7(b) that the uplink data transmission spans 5X time duration, and the first symbol is dropped (punctured) from the second X time period (start time period) to the latest X time period (i.e. the fifth X time period in FIG. 7(b)) (end time period) of the uplink NPUSCH transmission. Since TA can be updated before the start of uplink transmission, it is not necessary to drop (puncture) the first symbol of the first X time period. Therefore, the first symbol of the first X time period is not dropped. Note that the end of transmission may not be the end of an X time period, which means that the last X time period (the fifth X time period in FIG. 7(b)) may occupy less than X ms or less than X repetitions.

According to a variety of the second embodiment, the symbol to be dropped is located within a period from the start (Sp or Sn) of the last symbol of a X time period (e.g. first X time period in FIG. 7(c)) to the end (Ep or En) of the first symbol of a next X time period (e.g. second X time period in FIG. 7(c)). For example, the last half symbol of a first X time period and the first half symbol of a second X time period that is adjacent to the first X time period are dropped (punctured), as shown in FIG. 7(c) for the situations of both positive delta TA and negative delta TA, and TA is updated in these punctured durations. It is obvious that the total dropped length is one symbol (e.g. the last half symbol of a first X time period+the first half symbol of a second X time period). It can be seen from FIG. 7(c) that the last half symbol is dropped (punctured) from the first X time period (start time period 1) to the second latest X time period (i.e. the fourth X time period in FIG. 7(c)) (end time period 1) of the uplink NPUSCH transmission, and that the first half symbol is dropped (punctured) from the second X time period (start time period 2) to the latest X time period (i.e. the fifth X time period in FIG. 7(c)) (end time period 2) of the uplink NPUSCH transmission. The first half symbol of the first X time period is not dropped because it is unnecessary to update TA at the beginning of the first X time period. The last half symbol of the last X time period is not dropped because there is no uplink transmission after the last X time period (not necessary to update TA). Note that the end of transmission may not be the end of an X time period, which means that the last X time period (e.g. the fifth X time period in FIG. 7(c)) may occupy less than X ms or less than X repetitions.

According to the second embodiment, a Y time duration NPUSCH transmission is dropped (punctured) every X ms time interval or every X repetitions of NPUSCH transmission (abbreviated as X time period). The Y time duration is located within a 2*Y period starting from Sp or Sn and ending at Ep or En, wherein Sp or Sn is located Y time duration ahead of the end of a first X time period, and Ep or En is located Y time duration behind the start of a second X time period, where the end of the first X time period is the same as the start of the second X time period. When the Y time duration starts from Sp or Sn and ends at the end of the first X time period, it means that the last Y time duration of the first X time period is dropped (i.e. the situation of FIG. 7(a)). When the Y time duration starts from the start of the second X time period, it means that the first Y time duration of the second X time period is dropped (i.e. the situation of FIG. 7(b)). When the Y time duration starts from a position that is Y/2 time duration ahead of the end of the first X time period and ends at a position that is Y/2 time duration behind the start of the second X time period, it means that the last Y/2 time duration of the first X time period and the first Y/2 time duration of the second X time period are dropped (i.e. the situation of FIG. 7(c)).

From another point of view, the Y time duration is configured between every two adjacent X time periods. For example, in all of the situations shown in FIGS. 7(a) to 7(c), one Y time duration is configured (i.e. one Y time duration NPUSCH transmission is dropped) between every two adjacent X time periods (e.g. between first X time period and second X time period, between second X time period and third X time period, between third X time period and fourth X time period, etc).

According to the second embodiment, the uplink transmission is transmitted in a continuous duration. It can be understood that the continuous duration can be divided into a plurality of time periods, in which all of time periods except for the last time period have a time length X, and the last time period has a time length equal or smaller than X. In the examples of FIGS. 7(a) to 7(c), all of the time periods are indicated as “X time period” (e.g. first X time period, second X time period, third X time period, . . . ). Among these “X time period”s, the last “X time period” (or referred to as the latest “X time period”) (e.g. the fourth X time period in FIG. 7(a), or the fifth X time period in FIG. 7(b) or 7(c)) may occupy a time length that can be smaller than or equal to the time length of other “X time period”s.

The Y time duration is described as 1 symbol (i.e. 66.7 μs) in above examples. The Y time duration can alternatively be configured as other values such as half symbol (i.e. 33.3 μs), or a value determined by the delta TA.

According to a third embodiment, the gap insertion solution proposed in the first embodiment and the puncture data transmission proposed in the second embodiment are combined to support TA update during transmission. In particular, a transmission gap with length of Y0 is inserted after or within every X0 duration from the beginning of the uplink transmission. In addition, each X0 duration (if Y0 is inserted after every X0 duration) or each X0-Y0 duration (if Y0 is inserted within every X0 duration, which is equivalent to that Y0 is inserted after every X0-Y0 duration) is divided into a multiple of X1 time period (X1 ms time interval or X1 repetitions of NPUSCH transmission). Between every two adjacent X1 time periods within each X0 duration (or within each X0-Y0 duration), UE drops Y1 time duration NPUSCH transmission.

Similar to the second embodiment, the Y1 time duration is located within a 2*Y1 period starting from Y1 time duration ahead of the end of a first X1 time period of the two adjacent X1 time periods and ending at Y1 time duration behind the start of a second X1 time period of the two adjacent X1 time periods (where the end of the first X1 time period is the same as the start of the second X1 time period).

For NPUSCH, X0 can be configured as 256 ms, and Y0 is configured as 40 ms.

For NPRACH, X0 can be configured as 64*(preamble duration), and Y0 is configured as 40 ms.

X1 can be configured as 64 ms when the delay drift is ±20 μs/s. Y1 is configured as 1 symbol (i.e. 66.7 μs).

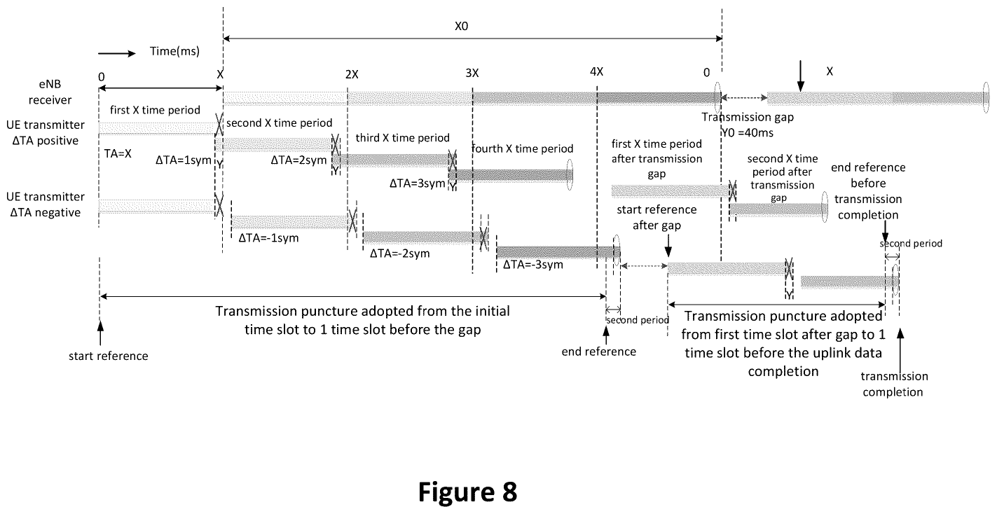

FIG. 8 shows an example of the third embodiment. FIG. 8 can be regarded as a combination of FIG. 6 and FIG. 7(a). In FIG. 8, X0 is configured as 4*X1 (X1=X); Y1 is configured as Y. After X0, a Y0 transmission gap (which is 40 ms in FIG. 8) is inserted. After the transmission gap, the uplink transmission restarts and continues until the completion of the uplink transmission. Within X0 (=4*X) time period, the last symbol is dropped from the first X time period (i.e. the first X time period in FIG. 8) to the second latest X period before the transmission gap (i.e. the third X time period in FIG. 8). Within the time period from the end the transmission gap to the completion of the uplink transmission, the last symbol is dropped from the first X time period after the transmission gap (i.e. the first X time period after transmission gap in FIG. 8) to the second latest X period before the end of uplink transmission (i.e. the first X time period after transmission gap in FIG. 8). The last symbol of the last X time period within X0 period (i.e. the fourth X time period) is not dropped (indicated as circles in FIG. 8). This is because the TA update can be done in the transmission gap. The last symbol of the last X time period before the completion of the uplink transmission (i.e. the second X time period after transmission gap) is not dropped (indicated as circles in FIG. 8). This is because data transmission is completed (no TA update is necessary).

FIG. 8 only illustrates one continuous uplink transmission with a length of X0. Depending on the length of the uplink transmission, there can be two or more continuous uplink transmissions with a length of X0, each of which is followed by a transmission gap Y0.

In the above description, the start of puncture and the end of puncture are described by counting the X time period. On the other hand, the start and the end of puncture can be indicated by a start reference and an end reference. The detailed explanation of the start reference and the end reference is made with reference to Figure.

As shown in FIG. 8, in the continuous uplink transmission with a length of X0 before the transmission gap, the start reference is indicated as the start of uplink transmission; the end reference is indicated as a second period (Z) before the transmission gap. In FIG. 8, the second period (Z) is shown as larger than Y. This is because Y is generally configured as a length of one symbol (or half symbol) while the TA update shall be done at a minimal interval of one slot. So, the second period is minimally one slot, that is longer than one symbol. From the start reference (the start of uplink transmission) to the end reference (a second period before the transmission gap), the last symbol is dropped (punctured) every X time period (every X ms or every X repetitions). Due to the reduction by the second period, the last X time period (the fourth X time period in FIG. 8) has a length shorter than X ms or X repetitions. Accordingly, the last symbol of the last X time period (the fourth X time period in FIG. 8) is not dropped. However, if the second period is configured as 0, it is acceptable that the last symbol of the last X time period (the fourth X time period in FIG. 8) is dropped.

The continuous uplink transmission after the transmission gap in FIG. 8 only includes “first X time period after transmission gap” and “second X time period after transmission gap” before the transmission is completed. The start reference after gap is indicated as a restart of the data transmission after the transmission gap. During the transmission gap, the uplink transmission is interrupted. The uplink transmission is resumed (restarted) after the transmission gap. The end reference before transmission completion is indicated as a second period before the transmission completion. As described above, the second period may be configured as one slot or 0. Incidentally, even if he second period is configured as 0, the last X time period (the second X time period after transmission gap in FIG. 8) may still have a length shorter than X ms or X repetitions.

As a whole, in FIG. 8, the start reference may be indicated as the start of uplink data transmission or a restart of the uplink data transmission after the transmission gap; and the end reference may indicated as a second period before the transmission gap or a second period before the uplink data transmission completion, where the second period can be configured as a slot duration or 0.

In FIG. 8, within each continuous uplink transmission, only the last symbol is dropped every X time duration. It is obviously possible that only the first symbol is dropped every X time duration, or a part of the last symbol and a part of the first symbol are dropped every X time duration (with a total dropped length of one symbol).

In the condition of the first symbol (or a part of the first symbol) is dropped (punctured), the start reference may be indicated as a time period (X) after the start of uplink data transmission, or a time period (X) after the transmission gap (i.e. the puncture starts from the second X time period). The end reference is still a second period before the transmission gap or a second period before the uplink data transmission completion, where the second period can be configured as a slot duration or 0.

According to the third embodiment, a transmission gap, during which the uplink data is not transmitted, is inserted after or within a data transmission period (X0). The same principal may apply to invalid uplink transmission time slot. Due to various reasons, some time slots may be configured as invalid uplink transmission time slots, during which uplink data cannot be transmitted. The TA update can be done during any of invalid uplink transmission time slots. From the point of view of TA update, each of invalid uplink transmission time slots can be regarded as a transmission gap according to the third embodiment.

In particular, the start reference may alternatively be a restart of the uplink data transmission after an invalid uplink transmission time slot, or a time period (X) after an invalid uplink transmission time slot. The end reference may alternatively be a second period before an invalid uplink transmission time slot, where the second period can be configured as a slot duration or 0.

In each of the periodic transmission gaps and each of the invalid uplink transmission time slots, both TA and frequency are updated. In the durations that uplink data transmission is dropped within every X0, TA is updated.

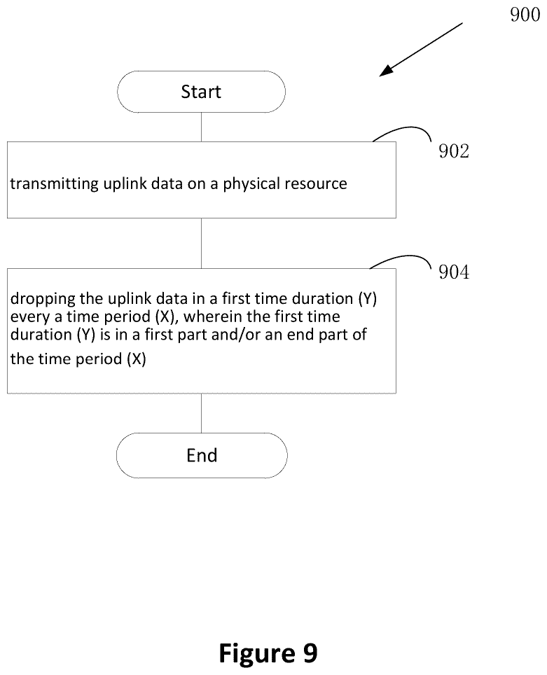

FIG. 9 is a schematic flow chart diagram illustrating an embodiment of a method 900 according to the present application. In some embodiments, the method 900 is performed by an apparatus, such as a remote unit. In certain embodiments, the method 900 may be performed by a processor executing program code, for example, a microcontroller, a microprocessor, a CPU, a GPU, an auxiliary processing unit, a FPGA, or the like.

The method 900 may include 902 transmitting uplink data on a physical resource; and 904 dropping the uplink data in a first time duration (Y) every a time period (X), wherein the first time duration (Y) is in a first part and/or an end part of the time period (X).

In the method 900, a gap period of a second time duration (Y0), during which the uplink data is not transmitted, can be inserted after or within a data transmission period (X0), wherein the data transmission period (X0) is configured by higher layer. The data transmission period (X0) may be configured as a multiple of the time period (X).

The uplink data is dropped every the time period (X) from a first time reference to a second time reference. The first time reference may be at least one of a start of uplink data transmission, a restart of uplink data transmission after the gap period, a restart of uplink data transmission after an invalid time slot, the time period (X) after the start of uplink data transmission, the time period (X) after the gap period, and the time period (X) after the invalid time slot. The second time reference is at least one of a second period (Z) before the gap period, a second period (Z) before the completion of uplink data transmission, and a second period before an invalid time slot. The second period can be one slot duration or 0.

In the condition that the uplink data is transmitted in a continuous time duration, the continuous time duration can be divided into a plurality of time periods, in which all of time periods except for the last time period have a time length X, and the last time period has a time length equal or smaller than X. In this condition, the time periods, the end part and/or the first part of each of which are dropped, can be alternatively indicated by the sequence of the time periods. For example, when the first time duration (Y) is in the end part of the time period, the time periods, the end part of each of which is dropped, start from a first time period from a start of the uplink data transmission and end at the second latest time period before the completion of uplink data transmission. When the first time duration (Y) is in the first part of the time period, the time periods, the first part of each of which is dropped, start from a second time period from a start of the uplink data transmission and end at the latest time period before the completion of uplink data transmission. When the first time duration (Y) is in the end part and the start part of the time period, the time periods, the end part of each of which is dropped, start from a first time period from a start of the uplink data transmission and end at the second latest time period before the completion of uplink data transmission, and the time periods, the first part of each of which is dropped, start from a second time period from a start of the uplink data transmission and end at the latest time period before the completion of uplink data transmission.

The first time duration (Y) can be configured by higher layer or fixed as 1 symbol. The time period (X) can be configured by higher layer or configured as multiple of a preamble duration or configured as multiple repetitions of the uplink data transmission.

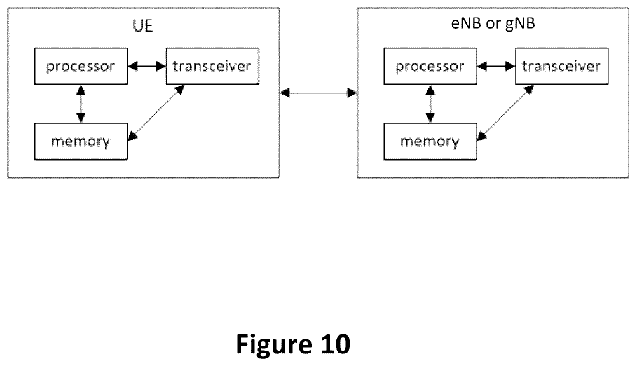

FIG. 10 is a schematic block diagram illustrating apparatuses according to one embodiment.

Referring to FIG. 10, the UE (i.e. the remote unit) includes a processor, a memory, and a transceiver. The processor implements a function, a process, and/or a method which are proposed in FIG. 9. The eNB or gNB (i.e. base unit) includes a processor, a memory, and a transceiver. Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

In particular, a remote unit comprises a transmitter that transmits uplink data on a physical resource; and a processor that drops the uplink data in a first time duration (Y) every time period (X), wherein the first time duration (Y) is in a first part and/or an end part of the time period (X).

When transmitting the uplink data, a gap period of a second time duration (Y0), during which the uplink data is not transmitted, can be inserted after or within a data transmission period (X0), wherein the data transmission period (X0) is configured by higher layer. The data transmission period (X0) may be configured as a multiple of the time period (X).

The uplink data is dropped every the time period (X) from a first time reference to a second time reference. The first time reference may be at least one of a start of uplink data transmission, a restart of uplink data transmission after the gap period, a restart of uplink data transmission after an invalid time slot, the time period (X) after the start of uplink data transmission, the time period (X) after the gap period, and the time period (X) after the invalid time slot. The second time reference is at least one of a second period (Z) before the gap period, a second period (Z) before the completion of uplink data transmission, and a second period before an invalid time slot. The second period can be one slot duration or 0.

In the condition that the uplink data is transmitted in a continuous time duration, the continuous time duration can be divided into a plurality of time periods, in which all of time periods except for the last time period have a time length X, and the last time period has a time length equal or smaller than X. In this condition, the time periods, the end part and/or the first part of each of which are dropped, can be alternatively indicated by the sequence of the time periods. For example, when the first time duration (Y) is in the end part of the time period, the time periods, the end part of each of which is dropped, start from a first time period from a start of the uplink data transmission and end at the second latest time period before the completion of uplink data transmission. When the first time duration (Y) is in the first part of the time period, the time periods, the first part of each of which is dropped, start from a second time period from a start of the uplink data transmission and end at the latest time period before the completion of uplink data transmission. When the first time duration (Y) is in the end part and the start part of the time period, the time periods, the end part of each of which is dropped, start from a first time period from a start of the uplink data transmission and end at the second latest time period before the completion of uplink data transmission, and the time periods, the first part of each of which is dropped, start from a second time period from a start of the uplink data transmission and end at the latest time period before the completion of uplink data transmission.

The first time duration (Y) can be configured by higher layer or fixed as 1 symbol. The time period (X) can be configured by higher layer or configured as multiple of a preamble duration or configured as multiple repetitions of the uplink data transmission.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A method, comprising:
transmitting uplink data on a physical resource,
wherein the uplink data is dropped in a first time duration (Y) every a time period (X), the first time duration (Y) is in a first part and/or an end part of the time period (X).

2. The method of claim 1, wherein, a gap period of a second time duration (Y0), during which the uplink data is not transmitted, is inserted after or within a data transmission period (X0), wherein the data transmission period (X0) is configured by higher layer.

3. The method of claim 2, wherein, the data transmission period (X0) is configured as a multiple of the time period (X).

4. The method of claim 1, wherein the uplink data is dropped every the time period (X) from a first time reference to a second time reference.

5. The method of claim 4, wherein the first time reference is at least one of a start of uplink data transmission, a restart of uplink data transmission after the gap period, a restart of uplink data transmission after an invalid time slot, the time period (X) after the start of uplink data transmission, the time period (X) after the gap period, and the time period (X) after the invalid time slot.

6. The method of claim 4, wherein the second time reference is at least one of a second period (Z) before the gap period, a second period (Z) before the completion of uplink data transmission, and a second period before an invalid time slot.

7. The method of claim 6, wherein the second period is one slot duration or The method of claim 1, wherein the uplink data is transmitted in a continuous time duration, the continuous time duration can be divided into a plurality of time periods, in which all of time periods except for the last time period have a time length X, and the last time period has a time length equal or smaller than X.

8. The method of claim 1, wherein the uplink data is transmitted in a continuous time duration, the continuous time duration can be divided into a plurality of time periods, in which all of time periods except for the last time period have a time length X, and the last time period has a time length equal or smaller than X.

9. The method of claim 8, wherein, when the first time duration (Y) is in the end part of the time period, the time periods, the end part of each of which is dropped, start from a first time period from a start of the uplink data transmission and end at the second latest time period before the completion of uplink data transmission.

10. The method of claim 8, wherein, when the first time duration (Y) is in the first part of the time period, the time periods, the first part of each of which is dropped, start from a second time period from a start of the uplink data transmission and end at the latest time period before the completion of uplink data transmission.

11. The method of claim 8, wherein, when the first time duration (Y) is in the end part and the start part of the time period, the time periods, the end part of each of which is dropped, start from a first time period from a start of the uplink data transmission and end at the second latest time period before the completion of uplink data transmission, and the time periods, the first part of each of which is dropped, start from a second time period from a start of the uplink data transmission and end at the latest time period before the completion of uplink data transmission.

12. The method of claim 1, wherein, the first time duration (Y) is configured by higher layer or fixed as 1 symbol.

13. The method of claim 1, wherein, the time period (X) is configured by higher layer or configured as multiple of a preamble duration or configured as multiple repetitions of the uplink data transmission.

14. A remote unit, comprising:
a transmitter that transmits uplink data on a physical resource; and
a processor that drops the uplink data in a first time duration (Y) every time period (X), wherein the first time duration (Y) is in a first part and/or an end part of the time period (X).

15. The remote unit of claim 14, wherein a gap period of a second time duration (Y0), during which the uplink data is not transmitted, is inserted after or within a data transmission period (X0), wherein the data transmission period (X0) is configured by higher layer.

16. The remote unit of claim 15, wherein the data transmission period (X0) is configured as a multiple of the time period (X).

17. The remote unit of claim 14, wherein the uplink data is dropped every the time period (X) from a first time reference to a second time reference.

18. The remote unit of claim 14, wherein the uplink data is transmitted in a continuous time duration, the continuous time duration can be divided into a plurality of time periods, in which all of time periods except for the last time period have a time length X, and the last time period has a time length equal or smaller than X.

19. The remote unit of claim 14, wherein the first time duration (Y) is configured by higher layer or fixed as 1 symbol.

20. The remote unit of claim 14, wherein the time period (X) is configured by higher layer or configured as multiple of a preamble duration or configured as multiple repetitions of the uplink data transmission.
